(19) United States
(12) Patent Application Publication
(10) Pub. No.: US 2003/0148170 A1
(43) Pub. Date: Aug. 7, 2003

(54) Electrolyte mixing in wet cell batteries

(76) Inventor: William E. M. Jones, Freeport (BS)

Correspondence Address: SYNNESTVEDT & LECHNER, LLP, 2600 ARAMARK TOWER, 1101 MARKET STREET, PHILADELPHIA, PA, 191072950

(21) Appl. No.: 10/359,760

(22) Filed: Feb. 6, 2003

Related U.S. Application Data
(60) Provisional application No. 60/354,550, filed on Feb. 6, 2002.

(51) Int. Cl. H01M 10/44; H01M 2/38

(52) U.S. Cl. 429/51; 429/81

(57) ABSTRACT

A method and device for mixing electrolyte in wet cell batteries having a pair of electrodes immersed in the electrolyte. An electric potential is created across the electrodes to generate hydrogen and oxygen gas bubbles which rise to the surface of the electrolyte, thereby mixing the electrolyte.

### CROSS-REFERENCE TO RELATED APPLICATION

This application claims the benefit U.S. Provisional Application No. 60/354,550 filed Feb. 6, 2002, which is hereby incorporated by reference in its entirety.

### FIELD OF THE INVENTION

The invention concerns an apparatus and a method for mixing electrolyte solution in wet cell batteries, particularly lead-acid cells.

### BACKGROUND OF THE INVENTION

If a conventional lead-acid battery cell is deeply discharged, its acid electrolyte will become depleted as the plates become sulfated and water is formed within the cell by the chemical reactions associated with discharge. On recharge, concentrated acid is released back from the plates and, having a higher specific gravity than the water, sinks to the bottom of the cell. This concentrated acid, if permitted to remain stratified, can damage the bottom of the plates. It is common, therefore, to have some method for mixing the acid with the water in the cell during the recharge process to prevent this stratification.

The most common method is to “gas” the cell at the end of charge by overcharging it. Overcharging causes electrolysis of the water within the cell and the production of H₂ and O₂ bubbles on the battery plates. The bubbles rise through the acid stratum, mixing it with the water and thereby prevent stratification. This method is also known as ionic mixing. The drawback to this method is that the electrolysis occurs over a relatively large surface area of the plates which results in (1) inefficient mixing since the bubbles which form above the stratum of concentrated acid do not contribute significantly to the mixing; and (2) significant loss of water from the cells, which, for a low maintenance battery or a maintenance free battery, must be limited.

The second method is by “air mixing” in which air is pumped into the cell through a thin tube positioned in the lower regions of the cell. The air bubbles rise and mix the electrolyte with little loss of water. (In practice, some water is lost by evaporation if the air supplied is dry.) To effect air mixing, an air pump is mounted on the battery charger and delivers air to the battery cells via a plastic tubing system. One problem with this method is that an uneven distribution of air through the small-bore tubing to the various cells in the battery can allow some cells to stratify due to insufficient mixing.

An improved method of mixing acid to prevent stratification is required that will conserve water (minimize electrolysis) and be more reliable than the charger-mounted air mixing method.

### BRIEF DESCRIPTION OF THE DRAWINGS

FIG. 1 is a schematic diagram of an apparatus for mixing electrolyte in a wet cell battery using two electrodes per cell;

FIG. 2 is a schematic diagram of an alternate embodiment of an apparatus for mixing electrolyte in a wet cell battery using two electrodes per cell;

FIG. 3 is a schematic of yet another embodiment of an apparatus for mixing electrolyte in a wet cell using two electrodes; and

FIG. 4 is of an alternate embodiment using a single electrode.

### DETAILED DESCRIPTION OF THE PRESENTLY PREFERRED EMBODIMENTS

Method 1. Electrolysis system with two electrodes

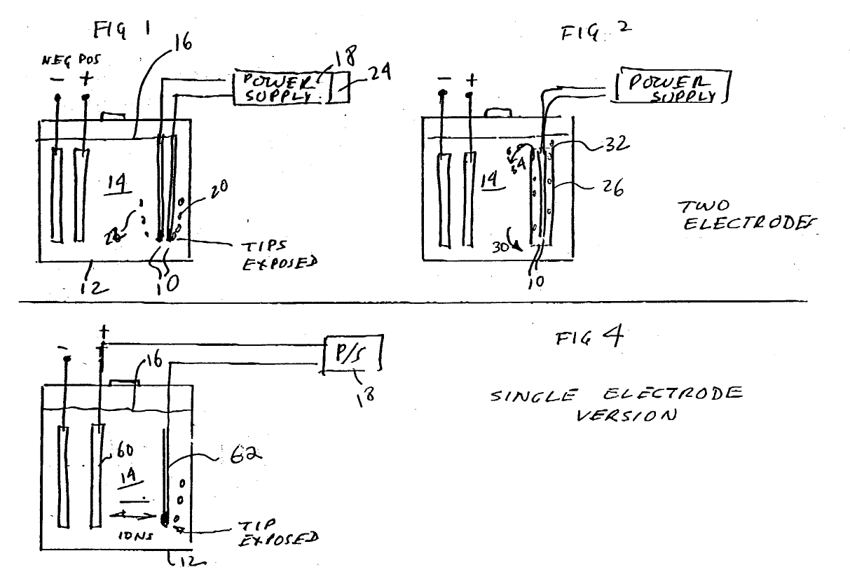

In one embodiment of the present invention shown in FIG. 1, a pair of electrodes 10, preferably made of lead compounds for use with a lead acid cell 12, are inserted into the electrolyte 14 of the cell 12, preferably well below the electrolyte free surface 16. A power supply 18 is electrically connected to the electrodes and applies an electrical potential difference to them. This causes a current to flow between the electrodes 10, and electrolysis of the, electrolyte 14 results with one of the electrodes, the cathode, producing hydrogen gas bubbles 20 and the other, the anode, producing oxygen gas bubbles 22. These bubbles rise to the to the free surface 16 and mix the electrolyte 14 to prevent acid stratification. The method using electrodes 10 according to the invention provides the following significant improvements over ionic and air mix methods.

(1) There are no pumps or air delivery tubes required; the mixing gas is generated in each cell where it is needed.

(2) Each cell in a battery gets a sufficient amount of gas bubbles 20 and 22 for effective mixing, proportional to the current passing between the electrodes 10. There are no distribution problems as encountered in the air mix method and consequently none of the cells in a battery will become stratified due to insufficient mixing.

(3) The amount of gas bubbles produced in a cell can be optimized for the exact size of that cell, small or large, by varying the current.

(4) Water loss due to electrolysis is limited by the ability to control the current through the electrodes to produce enough bubbles for effective mixing but not too many so as to prevent unacceptable water loss.

(5) Efficient mixing can be attained, thereby further reducing water loss, since the electrodes 10 may be placed in the acid stratum or positioned to pump acid from the stratum to other regions of the cell, as described below. This avoids the inefficient mixing of the ionic method where bubbles which form on the plates above the acid stratum do not contribute significantly to electrolyte mixing.

Mixing of the electrolyte by the method and apparatus according to the invention can be further improved by using an electronic controller 24 on the battery cell 12 or on the power supply 18. The controller may be, for example, a microprocessor under full software control which activates and controls the rate of gas generation in all or some of the cells (and hence the mixing in those cells) according to a strategy which optimizes parameters such as battery life, charging efficiency and water loss. For example, the controller 24 may activate the mixing of the electrolyte as soon as the battery is put on charge, or toward the end of charge, and control the rate of gas production, and hence the degree of mixing, by some functional relation dependent upon one or more parameters such as the rate of charging or discharging of the cells or the temperature of the battery.

The apparatus according to the invention is advantageously self-contained on the battery and needs no special chargers equipped with air pumps. The applied current may be AC or DC with DC preferred for simplicity. The current supplied to the electrodes may come from the battery itself or from an external power supply 18.

In a typical 2 volt lead acid cell, typically the cathode may be a rod of non-antimonial lead or lead alloy about ⅛ inch in diameter. The anode is similar except that it must be coated or shielded to minimize corrosion as described later. The applied voltage may be anything above 2.4 volts with a 6 volts being typical. The anode electrode produces oxygen and, if not protected, tends to oxidize or corrode quickly. Protection for a lead anode may be provided by a covering of oxide such as lead-dioxide, the active material of a positive plate, which will reduce the corrosion rate by several orders of magnitude. To keep the oxide in place, it should be wrapped in a porous sheath. An excellent, low-cost anode is a single tube taken from a tubular positive plate although anodes with smaller dimensions are preferred. Other anodes may also be used, many well known in the electroplating industry. For example, a titanium anode coated in iridium oxide would make a very long lasting anode but at a high cost.

The invention provides a very precise control over the amount of gas produced because Faraday's law requires that a current of 1 ampere will always produce 456 cc of hydrogen and 228 cc of oxygen, or 684 cc total gas, at room temperature.

Further improvements in the mixing method and apparatus according to the invention involve the details of how the electrodes interrelate and how the bubbles are formed. FIG. 2 shows the effect of surrounding the electrodes 10 by a tube 26 immersed within the electrolyte 14 within the cell 12. Use of the tube 26 causes a pumping action to occur which improves mixing of the electrolyte 14. Bubbles 20 and 22 form on the electrodes 10 and rise to the free surface 16. The bubble action draws electrolyte 14 into the bottom 28 of tube 26 as illustrated by arrow 30, the electrolyte passing up the tube to be discharged at the top 32 and shown by arrow 34. In experiments, a current of 1 ampere DC was passed through electrodes positioned within a cylindrical tube immersed within a bath of sulfuric acid with a specific gravity of 1.3. The result was a stream of small to medium sized bubbles that rose quickly to the acid surface, producing a strong pumping action, drawing acid from the bottom of the bath, up through the tube and discharging it at the top. A dye was injected into the bottom of the tube to visualize the acid flow path. The dye rapidly rose to the top of the tube. By varying the current from a fraction of 1 ampere to several amperes, the pumping rate could easily be adjusted.

Tube 26 is made of a non-conducting, acid-resistant material, preferably a polymer such as polypropylene. The tube may be non-porous or ionically porous, but the porosity should be such that gas bubbles do not easily pass through it.

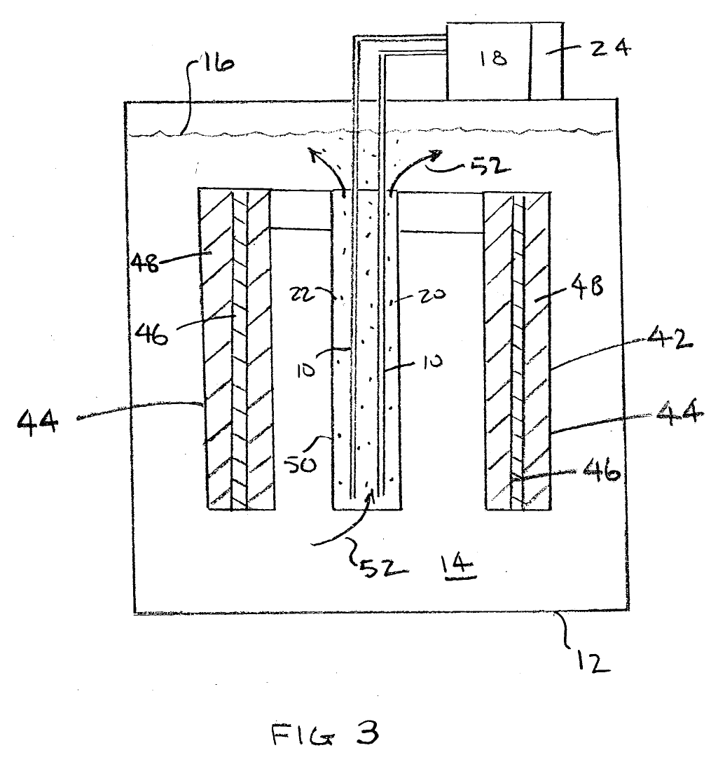

FIG. 3 illustrates another embodiment of the apparatus according to the invention wherein the plates 42 of the battery cell 12 are of the gauntlet type comprising a plurality of sleeves 44 of acid-resistant material which contain a lead spine 46 around which are packed lead oxides 48 comprising the active material of the plate which reacts with the electrolyte to generate the electrical current. At least one of the sleeves 50 does not contain the lead spine or the active lead material but, instead, houses the two electrodes 10 which are kept at different potentials by the power supply 18 and controller 24 as previously described to generate hydrogen and oxygen bubbles 20 and 22 by electrolysis. The bubbles rise up the sleeve 50 to the free surface 16 of the electrolyte, drawing electrolyte up the sleeve from the bottom to the top of the cell as shown by arrows 52 similarly to the tube embodiment described above to ensure adequate mixing of the electrolyte to prevent stratification of the acid.

Method 2: Electrolysis system with a single electrode.

To avoid the anodic corrosion problems of the first method above, the method shown in FIG. 4 eliminates the anode and instead uses the existing positive plates 60 of the cell as an anode. Therefore a single cathode electrode 62 is sufficient to create bubbles to mix the acid. The resulting design is very compact and will fit into most cells without special construction.

To produce the required electromotive force relative to the positive plate in the cell, the mixing electrode in each cell must be connected to its own isolated power supply 18 or, alternately, be driven by the voltage of an adjacent cell. This adjacent cell has a voltage nominally 2 volts more negative than the cell with the electrode.

For any given voltage, the amount of current drawn by the electrode is controlled by the amount electrode exposed. Typically, the electrode will be a lead rod of about ⅛ inch enclosed in a non-porous plastic tube but with its tip protruding a fraction of an inch or otherwise exposed to the acid and free ionic flow to the anode. The current drawn and therefore the gassing rate, may be chosen simply by selecting an appropriate amount of exposure of the anode to the electrolyte. The single lead electrode will not corrode even at high driving voltages because it is cathodically protected.

One tradeoff of this method is that, since the cathode only produces hydrogen, and hydrogen represents only two thirds of the constituents of water, it produces only two thirds as much gas at the electrode tip as the two-electrode method above. Also, since the positive plates are electrically involved in the process of mixing, the electrical connections are more complex as described below.

What is claimed is:

1. A method of mixing electrolyte in a wet cell battery, comprising:
providing a pair of electrodes in said wet cell battery, said electrodes being immersed in said electrolyte;
causing an electric current to flow between said electrodes so as to produce hydrogen and oxygen gas within said electrolyte; and
said electrolyte being mixed by the action of said hydrogen and oxygen gas rising to the surface of said electrolyte.

2. A method in accordance with claim 1 further comprising the step of constraining hydrogen and oxygen gas within a tube at least part of the way as it rises towards said surface of said electrolyte.

3. A wet cell battery, comprising:
a cell housing;
liquid electrolyte contained within said housing;
positive and negative electrodes immersed in said electrolyte;
a pair of electrodes unconnected electrically to said positive and negative electrode; and
a power supply connected to said pair of electrodes so as to be capable of causing an electric current to flow between said electrodes to produce hydrogen and oxygen gas within said electrolyte.

4. The battery of claim 3 wherein said pair of electrodes are disposed within a tube in which gas bubbles created by said pair of electrodes can rise to the surface of said electrolyte.

5. A method of mixing electrolyte in a wet cell battery having positive and negative plates, comprising:
providing an electrode immersed in said electrolyte separate from said positive and negative plates;
causing an electric current through said electrode to produce hydrogen and oxygen gas within said electrolyte; and
said electrolyte being mixed by the action of said hydrogen and oxygen gas rising to the surface of said electrolyte.

6. The method of claim 5 wherein said step of causing an electric current through said electrode to produce hydrogen and oxygen gas within said electrolyte is carried out by causing the current to flow between said electrode and one of said positive and negative plates.

7. The method of claim 6 wherein said electrode is a cathode and said one of said positive and negative plates comprises at least one of said positive plates.
